(19) United States
(12) Patent Application Publication
(10) Pub. No.: US 2017/0159639 A1
(43) Pub. Date: Jun. 8, 2017

(54) HYDRAULIC ROTARY MACHINE

(71) Applicant: KYB Corporation, Tokyo (JP)

(72) Inventors: Ryunosuke ISHIKAWA, Kanagawa (JP); Yoshihiro OOBAYASHI, Kanagawa (JP)

(73) Assignee: KYB Corporation, Tokyo (JP)

(21) Appl. No.: 15/324,443

(22) PCT Filed: Jun. 25, 2015
(86) PCT No.: PCT/JP2015/068372

§ 371 Date: Jan. 6, 2017

(30) Foreign Application Priority Data
Jul. 7, 2014 (JP) 2014-139544

(51) Int. Cl. F03C 1/06; F04B 9/115; F04B 3/00; F03C 1/22; F04B 1/22

(52) U.S. Cl. CPC F03C 1/0642; F03C 1/22; F04B 1/22; F04B 3/00; F04B 9/115

(57) ABSTRACT

A hydraulic piston pump motor in which water is used as a working fluid includes an axial directional passage opened on an end surface of one end of a shaft that couples to a cylinder block and drilled open along a shaft center of the shaft; a first radial directional passage drilled open along a radial direction of the shaft from the axial directional passage and configured to guide working fluid into a casing; a second radial directional passage drilled open from the axial directional passage along the radial direction of the shaft at a position closer to the one end of the shaft than the first radial directional passage; and an introduction passage communicating a passage, through which the higher pressure working fluid flows, among the supply passage and the discharge passage with the axial directional passage.

### TECHNICAL FIELD

The present invention relates to a hydraulic rotary machine in which water serves as a working fluid.

### BACKGROUND ART

A hydraulic piston pump such as one described in JP8-247021A is known as a hydraulic rotary machine in which water serves as a working fluid. JP8-247021A discloses a hydraulic axial piston pump having a shaft that is supported by a bearing and a cylinder block coupled to the shaft by a spline, and discharging water as the working fluid.

### SUMMARY OF INVENTION

The hydraulic piston pump such as the one described in JP8-247021A does not include a structure for actively cooling down sliding portions such as bearings and spline joint portions. Therefore, the temperature of the sliding portions increase due to frictional heat, which may cause the risk of erosion and abnormal wear of members that constitute the sliding portion, thus serving as a cause for the decrease in the durability of the pump.

The present invention has an object to improve the durability of a hydraulic rotary machine.

According to one aspect of the present invention, a hydraulic rotary machine in which water is used as a working fluid includes a plurality of pistons; a cylinder block having a plurality of cylinders which accommodates the pistons and being rotatable; a shaft penetrating through the cylinder block and coupling to the cylinder block; a swash plate configured to reciprocate the piston in accordance with the rotation of the cylinder block so as to expand and contract a capacity chamber of the cylinder; a casing accommodating the cylinder block, the casing supporting one end of the shaft, the other end of the shaft being inserted through the casing; a supply passage provided in the casing and configured to supply the working fluid to the capacity chamber; a discharge passage provided in the casing and configured to introduce the working fluid discharged from the capacity chamber; an axial directional passage opened on an end surface of the one end of the shaft and drilled open along a shaft center of the shaft; a first radial directional passage drilled open along a radial direction of the shaft from the axial directional passage and configured to guide the working fluid inside the casing; a second radial directional passage drilled open along the radial direction of the shaft from the axial directional passage at a position closer to the one end of the shaft than the first radial directional passage and configured to guide the working fluid inside the casing; and an introduction passage configured to communicate a passage, through which the higher pressure working fluid flows, among the supply passage and the discharge passage with the axial directional passage.

### BRIEF DESCRIPTION OF DRAWINGS

FIG. 1 is a sectional view of a hydraulic rotary machine according to an embodiment of the present invention;

FIG. 2 is a sectional view of a hydraulic rotary machine according to an embodiment of the present invention; and

FIG. 3 is a sectional view of a modified example of the hydraulic rotary machine according to an embodiment of the present invention.

### DESCRIPTION OF EMBODIMENTS

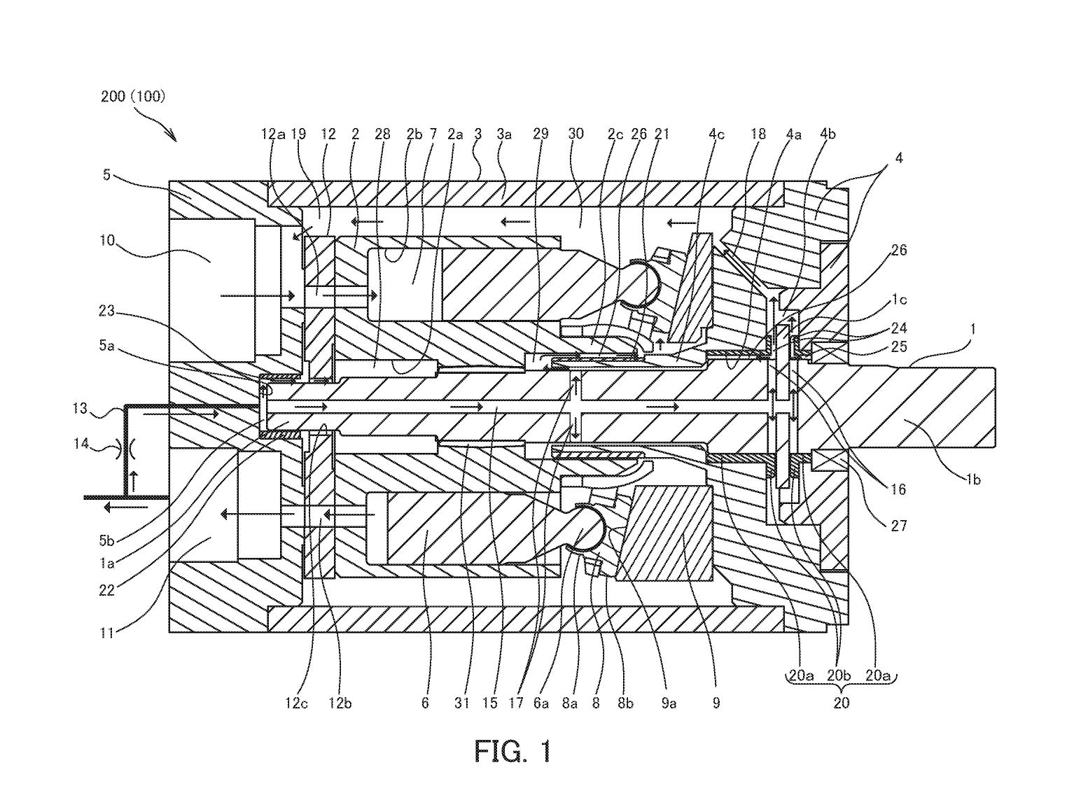

Hereinafter, a hydraulic rotary machine according to an embodiment of the present invention will be described, with reference to FIG. 1.

The present embodiment describes a case where the hydraulic rotary machine is a hydraulic piston pump motor 100 in which water serves as working fluid. The hydraulic piston pump motor 100 functions as a pump that supplies water serving as the working fluid, by a shaft 1 rotating by power transmitted from the outside and pistons 6 reciprocating due to the rotation, and functions as a motor that outputs rotation drive force, by the pistons 6 reciprocating by fluid pressure of water supplied from the outside and the shaft 1 rotating due to the reciprocation.

The description hereinafter exemplifies a case in which the hydraulic piston pump motor 100 is used as a piston pump 200, and the hydraulic piston pump motor 100 will simply be called as the “piston pump 200”.

The piston pump 200 is a hydraulic piston pump in which water serves as the working fluid. The piston pump 200 includes a shaft 1 that rotates by a power source, a cylinder block 2 coupled to the shaft 1 and which rotates in accordance with the rotation of the shaft 1, and a casing 3 that accommodates the cylinder block 2. The casing 3 includes a case main body 3a whose both ends are opened, an end cover 5 that supports one end 1a of the shaft 1 and closes one of the opened ends of the case main body 3a, and a front cover 4 through which the other end 1b of the shaft 1 is inserted and which closes the other one of the opened ends of the case main body 3a.

The one end 1a of the shaft 1 is accommodated in an accommodation recessed portion 5a provided in the end cover 5. The other end 1b of the shaft 1 projects externally from the front cover 4, and is coupled to the power source. The shaft 1 has a flange portion 1c that is formed projecting annularly from the outer circumferential surface thereof in a radial direction. The flange portion 1c is accommodated in the front cover 4, and regulates the relative movement of the shaft 1 and the front cover 4 in an axial direction.

The cylinder block 2 has a through hole 2a through which the shaft 1 penetrates, and is splined to the shaft 1 at a coupling portion 31. Accordingly, the cylinder block 2 rotates in accordance with rotation of the shaft 1.

In the cylinder block 2, a plurality of cylinders 2b having an opening on one end surface thereof is formed in parallel to the shaft 1. The plurality of cylinders 2b is formed at predetermined intervals in a circumferential direction of the cylinder block 2. A columnar piston 6 that partitions a capacity chamber 7 is inserted into the cylinder 2b in a reciprocatable manner. A leading end side of the piston 6 projects from the opening of the cylinder 2b, and a spherical base 6a is formed on a leading end portion thereof.

The piston pump 200 further includes shoes 8 respectively coupled to the spherical base 6a of the pistons 6 in a rotatable manner, and swash plates 9 with which a respective one of the shoes 8 is brought into sliding contact in accordance with the rotation of the cylinder block 2.

The shoe 8 includes a receiving portion 8a that receives the spherical base 6a formed on the leading end of the piston 6, and a circular flat plate portion 8b that is brought into sliding contact with the swash plate 9. An inner surface of the receiving portion 8a is formed in a spherical shape, and is brought into sliding contact with an outer surface of the received spherical base 6a. The angle of the shoe 8 can be changeable in any direction with respect to the spherical base 6a.

The swash plate 9 is fixed to an inner wall of the front cover 4, and has a sliding contact surface 9a tilted from a direction perpendicular to an axis of the shaft 1. The flat plate portion 8b of the shoe 8 is brought into surface contact with the sliding contact surface 9a.

A through hole 4a through which the shaft 1 is inserted, an accommodation portion 4b in which the flange portion 1c of the shaft 1 is accommodated, and a guide passage 18 communicating the accommodation portion 4b with the inside of the case main body 3a, are formed in the front cover 4. The through hole 4a and the accommodation portion 4b accommodates a first bearing 20 that supports the shaft 1 and the flange portion 1c in a rotatable manner. The guide passage 18 may be just one, or a plurality thereof may be provided.

The first bearing 20 includes a pair of cylindrical portions 20a disposed between the front cover 4 and the shaft 1, and a pair of annular portions 20b disposed between the front cover 4 and the flange portion 1c and which annularly projects in a radial direction from each end of the pair of cylindrical portions 20a. The pair of cylindrical portions 20a support the shaft 1 in a rotatable manner. The pair of annular portions 20b are formed sandwiching the flange portion 1c from both its sides, and supports the flange portion 1c in a rotatable manner by opposing surfaces that face each other. In such a way, the front cover 4 supports the shaft 1 in a rotatable manner via the first bearing 20.

The front cover 4 further has a tubular extending portion 4c formed thereto which extends towards the cylinder block 2 along the shaft 1. A second bearing 21 is inserted onto an outer circumferential surface of the extending portion 4c, and is fixed by a pin member or like member not illustrated.

A tubular sliding contact portion 2c is formed in the cylinder block 2 which is positioned facing the outer circumferential surface of the extending portion 4c and is brought into sliding contact with the second bearing 21. Since the inner circumferential surface of the sliding contact portion 2c is brought into sliding contact with the outer circumferential surface of the second bearing 21, the cylinder block 2 is supported in a rotatable manner by the front cover 4.

A supply passage 10 that guides water to be sucked into the capacity chamber 7 and a discharge passage 11 that guides water discharged from the capacity chamber 7 are formed in the end cover 5. The end cover 5 further includes a third bearing 22 that fits to the inner circumferential surface of the accommodation recessed portion 5a. The end cover 5 supports the one end 1a of the shaft 1 that is accommodated in the accommodation recessed portion 5a in a rotatable manner, via the third bearing 22.

The first to third bearings 20 to 22 are all slide bearings, and are formed of resin, ceramic, DLC (Diamond Like Carbon) or like material. The material of the first to third bearings 20 to 22 may be any material as long as it can ensure slidability, particularly even when the working fluid is water.

The piston pump 200 further includes a valve plate 12 interposed between the cylinder block 2 and the end cover 5.

The valve plate 12 is a disc member with which a base end surface of the cylinder block 2 is brought into sliding contact, and is fixed to the end cover 5. A supply port 12a connecting the supply passage 10 with the capacity chamber 7, a discharge port 12b connecting the discharge passage 11 with the capacity chamber 7, and a through hole 12c through which the shaft 1 penetrates, are formed in the valve plate 12.

The inside of the casing 3 is filled with water, and is mainly divided into a first internal space 28, a second internal space 29 and a third internal space 30. A first internal space 28 is defined by the through hole 2a of the cylinder block 2, the outer circumferential surface of the shaft 1, and the valve plate 12. A second internal space 29 is defined by an inner circumferential surface of the sliding contact portion 2c of the cylinder block 2, the extending portion 4c of the front cover 4, and the outer circumferential surface of the shaft 1. A third internal space 30 is the internal space of the case main body 3a excluding these first internal space 28 and second internal space 29.

Next, actions of the piston pump 200 will be described.

When the shaft 1 is driven and rotated by power transmitted from the outside and the cylinder block 2 is rotated, the flat plate portions 8b of the shoes 8 are brought into sliding contact with the respective swash plate 9, and the pistons 6 reciprocate within the cylinders 2b by a stroke amount in accordance with a tilting angle of the swash plate 9. The reciprocation of the pistons 6 causes the capacities of the capacity chambers 7 to increase or decrease.

Water is guided to the capacity chamber 7 that is enlarged by rotation of the cylinder block 2, through the supply passage 10 and the supply port 12a. Pressure of the water suctioned into the capacity chamber 7 is increased by reduction of the capacity chambers 7 due to the rotation of the cylinder block 2, and the water is discharged through the discharge port 12b and the discharge passage 11. In such a way, suction and discharge of the water are continuously performed in accordance with the rotation of the cylinder block 2, in the piston pump 200.

Next described is a structure of a cooling passage of the piston pump 200.

In the embodiment shown in FIG. 1, high pressure water being pressurized in the capacity chamber 7 flows through the discharge passage 11. In the present embodiment, an introduction passage 13 that communicates the discharge passage 11 with the accommodation recessed portion 5a is formed, in order to use the water flowing through the discharge passage 11 for cooling the sliding portion within the casing 3. The introduction passage 13 may be formed on either of the inside or outside of the end cover 5. For example, a groove serving as the introduction passage 13 may be formed on either of the end cover 5 or the valve plate 12 at a contact surface of the end cover 5 and the valve plate 12, or a port connecting the discharge passage 11 and the accommodation recessed portion 5a may be drilled open on the end cover 5. The introduction passage 13 is provided with an orifice 14 that limits the amount of water guided inside the casing 3.

The third bearing 22 disposed in the accommodation recessed portion 5a is provided with a first connection passage 23 on its inner circumferential surface, which is a groove extending in an axial direction and communicates an accommodation space 5b of the accommodation recessed portion 5a with the inside of the casing 3. A part of the water guided through the introduction passage 13 to the accommodation space 5b, after passing through the first connecting passage 23, is guided to the first internal space 28 through a gap between the through hole 12c of the valve plate 12 and the shaft 1. In order to guide the water flowed through the first connecting passage 23 to the supply passage 10, a groove that communicates with the supply passage 10 may be formed on either of the end cover 5 or the valve plate 12, at the contact surface of the end cover 5 and the valve plate 12. Moreover, in order to guide the water flowed through the first internal space 28 to the supply passage 10, a passage communicating the first internal space 28 with the second internal space 29 or the third internal space 30 may be provided in the cylinder block 2 or the valve plate 12.

An axial directional passage 15 opened on an end surface of the one end 1a and drilled open along a shaft center of the shaft 1, a first radial directional passage 16 drilled open along a radial direction of the shaft 1 from the axial directional passage 15 and opened on an outer circumferential surface of the shaft 1 facing the front cover 4, and a second radial directional passage 17 provided closer to the one end 1a of the shaft 1 than the first radial directional passage 16 and opened on the outer circumferential surface of the shaft 1 that faces the extending portion 4c of the front cover 4, are formed in the shaft 1. The axial directional passage 15 communicates with the introduction passage 13 through the accommodation space 5b, so thus pressurized water is guided through the axial directional passage 15 via the introduction passage 13. The open position of the second radial directional passage 17 is not limited to a position facing the extending portion 4c of the front cover 4, and may be anywhere on the shaft 1 as long as it is a position where water can be supplied to the second internal space 29.

In the present embodiment, the axial directional passage 15 is a non-through-hole that is drilled open in the axial direction of the shaft 1 so as to pass through the shaft center from the end surface of the one end 1a of the shaft 1. The first radial directional passage 16 and the second radial directional passage 17 are through holes that communicate with the axial directional passage 15, drilled open in a radial direction and opened at the outer circumferential surface of the shaft 1. The first radial directional passage 16 are formed as two passages opening at positions facing the pair of cylindrical portions 20a of the first bearing 20, and the second radial directional passage 17 is provided closer to the one end 1a of the shaft 1 than the first radial directional passage 16 and is formed as one passage open to the second internal space 29. The diameters and the numbers of the first radial directional passage 16 and the second radial directional passage 17 are determined so that the amount of water flowing through both passages are of a sufficient amount to cool each of the portions. In order to adjust the amount of water flowing through the first radial directional passage 16 and the second radial directional passage 17, an orifice may be disposed to any one or a plurality of the first radial directional passage 16, the second radial directional passage 17, and the axial directional passage 15 between the first radial directional passage 16 and the second radial directional passage 17. By disposing an orifice to these passages, the amount of water supplied to each of the first bearing 20 and second bearing 21 can be adjusted, and the first bearing 20 and the second bearing 21 can be appropriately cooled.

An opposing surface of the pair of annular portions 20b of the first bearing 20 is formed with a second connecting passage 24 that is a radial directional groove provided extending radially in a groove shape. The second connecting passage 24 communicates with the guide passage 18 via the accommodation portion 4b of the front cover 4.

The cylindrical portion 20a of the first bearing 20 has a third connecting passage 25 formed thereto, which is an axial directional groove provided extending axially in a groove shape on the inner circumferential surface of the cylindrical portion 20a. The third connecting passage 25 is formed to communicate with the first radial directional passage 16 and the second connecting passage 24. Therefore, the first radial directional passage 16 communicates with the guide passage 18 through the third connecting passage 25 and the second connecting passage 24. Accordingly, water guided from the axial directional passage 15 to the first radial directional passage 16 and flowed out from the first radial directional passage 16 are guided to the guide passage 18 through the third connecting passage 25 and the second connecting passage 24. The front cover 4 has sealing material 27 disposed thereto, so that no water leaks outside from between the shaft 1 and the front cover 4. Therefore, no water will leak outside through the third connecting passage 25.

Since the guide passage 18 communicates the accommodation portion 4b with the third internal space 30, the water guided through the second connecting passage 24 is guided to the third internal space 30 through the accommodation portion 4b and the guide passage 18.

A fourth connecting passage 26 is formed in the second bearing 21, fourth connecting passage 26 being an axial directional groove provided extending axially in a groove shape on the outer circumferential surface of the second bearing 21. The fourth connecting passage 26 communicates the second internal space 29 with the third internal space 30. Since the second radial directional passage 17 is opened to the second internal space 29, the water flowing out from the second radial directional passage 17, after flowing into the second internal space 29, is guided to the third internal space 30 through the fourth connecting passage 26 formed in the second bearing 21.

A recirculation passage 19 is formed between the valve plate 12 and the case main body 3a, the recirculation passage 19 communicating the supply passage 10 with the third internal space 30. The recirculation passage 19 is a gap formed between the outer circumferential surface of the valve plate 12 and an inner circumferential surface of the case main body 3a. Therefore, the water guided into the third internal space 30 through the first radial directional passage 16 and the second radial directional passage 17 recirculates to the supply passage 10 through the recirculation passage 19.

Next, a cooling effect of the piston pump 200 will be described with reference to FIG. 1. As shown by the arrows in FIG. 1, a part of the water pressurized at the piston pump 200 circulates within the piston pump 200, and cools each of the portions.

A portion of the water guided from the discharge passage 11 to the accommodation recessed portion 5a through the introduction passage 13 flows through the first connecting passage 23 formed in the third bearing 22. At this time, the third bearing 22 is cooled by the water flowing through the first connecting passage 23. The water passing through the first connecting passage 23 flows inside the first internal space 28, and cools the coupling portion 31 of the shaft 1 and the cylinder block 2, which is positioned adjacent to the first internal space 28, and the sliding contact surface of the cylinder block 2 and the valve plate 12.

A portion of the water flowing into the axial directional passage 15 of the shaft 1 flows out from the shaft 1 through the second radial directional passage 17, and is guided to the second internal space 29. The water guided into the second internal space 29 cools the coupling portion 31 of the shaft 1 and the cylinder block 2, which is positioned adjacent to the second internal space 29. Thereafter, the water guided into the second internal space 29 is guided to the third internal space 30 through the fourth connecting passage 26 formed in the second bearing 21. At this time, the second bearing 21 is cooled by the water flowing through the fourth connecting passage 26. The water guided from the second internal space 29 to the third internal space 30 cools each of the sliding portions of the piston 6, the shoe 8, and the swash plate 9, each of which are disposed inside the third internal space 30.

Furthermore, the water flowed into the axial directional passage 15 of the shaft 1 flows out from the shaft 1 through the first radial directional passage 16. The water flowing out from the first radial directional passage 16 is guided to the third internal space 30, through the third connecting passage 25 and second connecting passage 24 formed in the first bearing 20, and through the accommodation portion 4b and guide passage 18 formed in the front cover 4. At this time, the first bearing 20 is cooled by the water flowing through the third connecting passage 25 and the second connecting passage 24.

The water guided to the third internal space 30, after cooling the sliding portions of each of the members disposed within the third internal space 30, is recirculated to the supply passage 10 through the recirculation passage 19.

According to the above embodiments, the following effects are obtained.

The water guided inside the shaft 1 are guided into the casing 3 through the first radial directional passage 16 and the second radial directional passage 17 provided closer to the one end 1a of the shaft 1 than the first radial directional passage 16. It is thus possible to efficiently and simultaneously cool the sliding portions of those such as each of the bearings and spline coupling portions. Therefore, erosion and abnormal wear of the sliding portion that occur due to frictional heat is prevented, hence the durability of the hydraulic piston pump motor 100 can be improved.

Moreover, in each of the sliding contact surfaces of the first, second, and third bearings 20, 21, 22, a groove serving as connecting passages that constitute a part of a circulation path are formed. Therefore, the water circulating within the piston pump 200 simultaneously cools the sliding surfaces of the first, second, and third bearings 20, 21, 22, while also functioning as a lubricant. As a result, the wearing of the sliding contact surface is reduced, and the durability of the first, second, and third bearings 20, 21, 22 can each be improved. Furthermore, the frictional resistance of the bearing is reduced, thus improving pumping efficiency.

The following describes a modified example of the hydraulic piston pump motor 100 according to the embodiment of the present invention shown in FIG. 1.

In the above embodiment, the recirculation passage 19 is formed between the outer circumferential surface of the valve plate 12 and the inner circumferential surface of the case main body 3a. However, the recirculation passage 19 can be configured in any way as long as it communicates the inside of the case main body 3a with the supply passage 10. For example, the recirculation passage 19 can be a hole formed in the valve plate 12 or a groove formed on the outer circumferential surface of the valve plate 12.

Furthermore, in the above embodiment, the recirculation passage 19 is formed between the outer circumferential surface of the valve plate 12 and the inner circumferential surface of the case main body 3a. Instead of this, a drain port (illustration omitted) provided in the case main body 3a may serve as the recirculation passage. In this case, the water guided inside the casing 3 is discharged from the drain port to a tank (illustration omitted). The water in the tank is again supplied to the piston pump 200 through the supply passage 10. As such, since the water guided inside the casing 3 is discharged through the drain port to the supplying side and again supplied to the piston pump 200, a circulation passage for the water for cooling is formed.

Furthermore, in the above embodiment, the first radial directional passage 16 is provided as two through holes that penetrate through the shaft 1 in the radial direction thereof. As long as the first radial directional passage 16 is of a configuration that communicates the axial directional passage 15 with the third connecting passage 25, there may be just one, a plurality thereof may be formed in a circumferential form, or the first radial directional passage 16 may not be a through hole. Similarly, as long as the second radial directional passage 17 is of a configuration that communicates the axial directional passage 15 with the second internal space 29, there may be just one, a plurality thereof may be formed in a circumferential form, or the second radial directional passage 17 may not be a through hole.

Furthermore, the above embodiment describes that the third connecting passage 25 connects the first radial directional passage 16 with the second connecting passage 24. Instead of this, the first radial directional passage 16 may be formed to directly communicate with the second connecting passage 24. In this case, the third connecting passage 25 may be provided in the first bearing 20 for lubrication, or may not be provided.

Furthermore, in the above embodiment, the first, second, third, and fourth connecting passages 23, 24, 25, 26 are grooves provided on the bearings. Instead of this, the first, second, third, and fourth connecting passages 23, 24, 25, 26 may be gaps formed between the shaft 1 or the cylinder block 2 and the bearings.

Furthermore, in a case in which grooves are formed as the first, second, third, and fourth connecting passages 23, 24, 25, 26, just one each need to be provided. Moreover, the second connecting passage 24 is sufficiently provided on just at least one of the pair of the annular portions 20b of the first bearing 20. The third connecting passage 25 is sufficiently provided on just at least one of the pair of the cylindrical portions 20a of the first bearing 20.

Furthermore, the shaft 1 has the flange portion 1c formed thereon, which projects annularly in the radial direction, and the first bearing 20 includes the annular portion 20b that supports the flange portion 1c in a rotatable manner. Instead of this, no flange portion 1c may be formed, and the first bearing 20 may serve as a tubular bearing. In this case, holes and grooves may be formed in the radial direction of the bearing, to serve as the second connecting passage 24.

Furthermore, the orifice 14 provided for the introduction passage 13 may be of a fixed type or a variable type. When using the variable type, the aperture of the orifice 14 is adjusted according to the temperature inside the casing 3, and the orifice 14 may be controlled so that the amount of water guided inside the casing 3 is increased as the temperature within the casing 3 increases.

Moreover, in the above embodiment, the swash plate 9 is of a fixed angle type, but this may be one whose tilting angle can be changed.

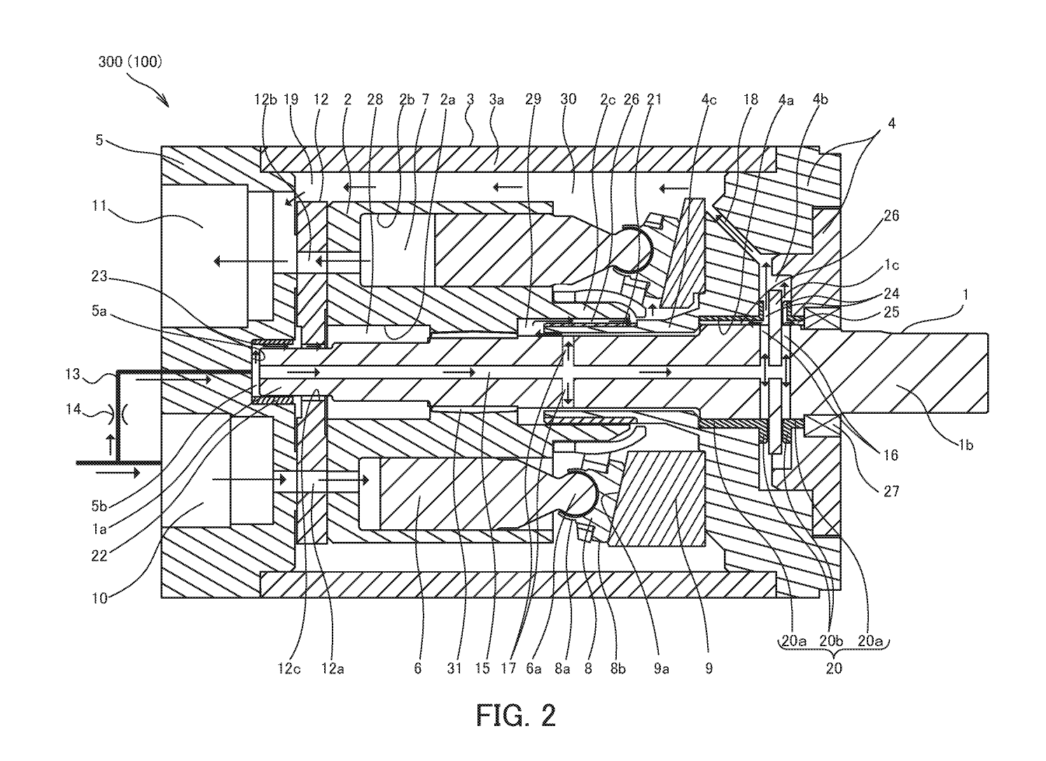

Next described with reference to FIG. 2 is a case in which the hydraulic piston pump motor 100 according to the embodiment of the present invention is used as a piston motor 300.

When the hydraulic piston pump motor 100 is used as the piston motor 300, high pressure water is supplied from the outside to the piston motor 300 through the supply passage; thus, the passage through which a high pressure working fluid passes among the supply passage 10 and the discharge passage 11 will be the supply passage 10. On the other hand, the discharge passage 11 communicates with a tank not illustrated, and the water discharged from the capacity chamber 7 flows through the discharge passage 11. Therefore, the embodiment shown in FIG. 2 differs from the embodiment shown in FIG. 1 in that the introduction passage 13 is connected to the supply passage 10 and the recirculation passage 19 is connected to the discharge passage 11.

The water guided from the supply passage 10 through the introduction passage 13, as with the case of the piston pump 200 shown in FIG. 1, is guided into the casing 3 through the axial directional passage 15 formed in the shaft 1, and cools each of the sliding portions. The water guided into the casing 3 is guided to the discharge passage 11 through the recirculation passage 19, and is discharged to the tank together with the water discharged from the capacity chamber 7. Any other structures and effects are identical to the piston pump 200 shown in FIG. 1, and thus descriptions thereof have been omitted.

As described above, even in the case in which the hydraulic piston pump motor 100 is used as the piston motor 300, the water guided inside the shaft 1 is guided into the casing 3 through the two passages, that is, the first radial directional passage 16 and the second radial directional passage 17. This thus allows for simultaneously cooling the sliding portions such as each of the bearings and spline coupling portions, efficiently. Therefore, the erosion and abnormal wear of the sliding portion caused by the frictional heat is suppressed, hence the durability of the hydraulic rotary machine can be improved.

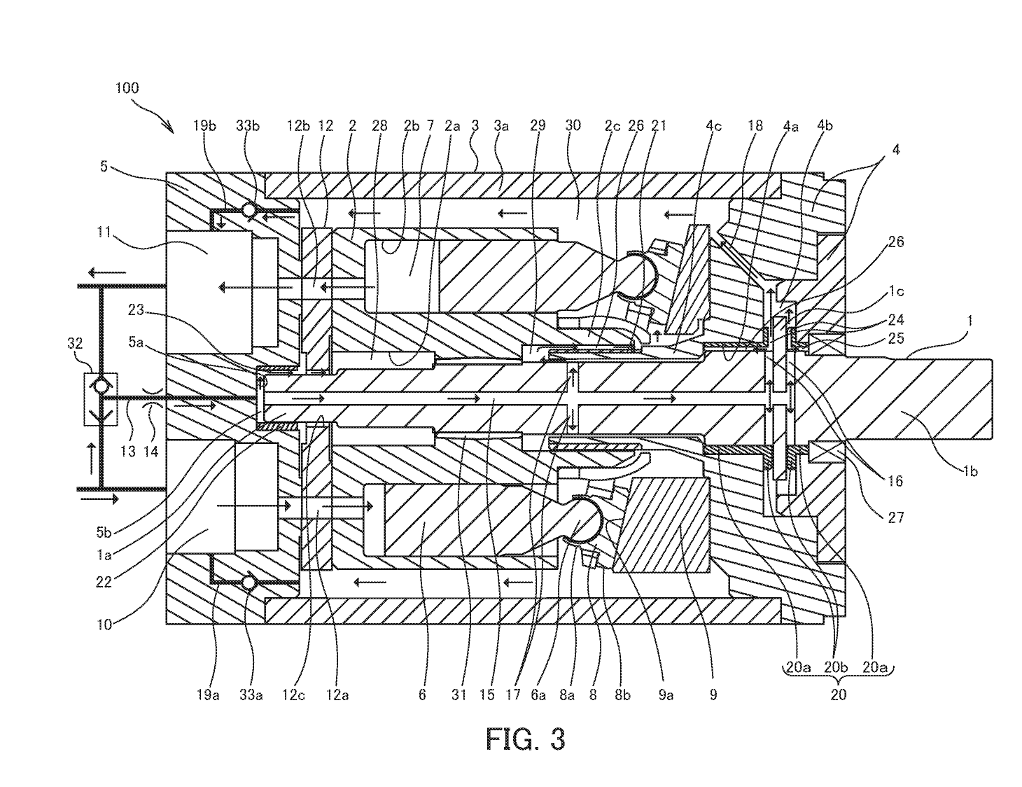

Next described is a modified example of the hydraulic piston pump motor 100, with reference to FIG. 3.

The hydraulic piston pump motor 100 shown in FIG. 3 differs from the hydraulic piston pump motors 100 shown in FIG. 1 and FIG. 2 in that the introduction passage 13 is connected to both the supply passage 10 and the discharge passage 11 via a selector valve 32, and that a recirculation passage is configured of a passage 19a communicating the third internal space 30 with the supply passage 10, a check valve 33a provided to this passage 19a for allowing just the flowing out of water from the third internal space 30 to the supply passage 10, a passage 19b communicating the third internal space 30 with the discharge passage 11, and a check valve 33b provided in this passage 19b for allowing just the flowing out of water from the third internal space 30 to the discharge passage 11.

The selector valve 32 has two inlets and one common outlet, the supply passage 10 and the discharge passage 11 are connected to the inlets, and the introduction passage 13 is connected to the outlet. The selector valve 32 compares the pressure of the water supplied via the two inlets, since the inlet of the higher pressure is made to communicate with the outlet, just the passage among the supply passage 10 and the discharge passage 11, through which the higher pressure water flows, communicates with the introduction passage 13. Therefore, for example, when the hydraulic piston pump motor 100 including the supply passage 10 and the discharge passage 11 is used as the piston pump and the rotational direction of the shaft 1 switches, and the passage from which the pressurized water is discharged switches from one passage to the other passage, or when the passage through which the pressurized water is supplied for switching the rotational direction of the shaft 1 when used as a piston motor is switched over from one passage to the other passage, the passage communicating with the introduction passage 13 switches from one passage to the other passage that flows the high pressure water therethrough by the selector valve 32. That is to say, in the hydraulic piston pump motor 100 shown in FIG. 3, the introduction passage 13 constantly communicates with the passage through which the high pressure water flows, hence the high pressure water can be constantly guided into the casing 3 in any case of how the hydraulic piston pump motor 100 is used.

Moreover, the recirculation passage is configured of the passages and the check valves, however when the hydraulic piston pump motor 100 is used as the piston pump, either one of the passage of the supply passage 10 or the discharge passage 11 will serve as a suction passage having a low pressure even when the rotational direction of the shaft 1 switches. So the water guided into the casing 3 recirculates through the check valve that is connected to the passage serving as the suction passage, and is sucked into the capacity chamber 7 together with the water supplied from the tank not illustrated. Similarly, in a case in which the hydraulic piston pump motor 100 is used as the piston motor, even when the passage that supplies high pressure water is switched over to switch the rotational direction of the shaft 1, either one of the passages of the supply passage 10 and the discharge passage 11 serves as the discharge passage communicating with the tank not illustrated. Accordingly, the water guided into the casing 3 is recirculated through the check valve that is connected to the passage serving as the discharge passage, and returns to the tank together with the water discharged from the capacity chamber 7. As such, in the hydraulic piston pump motor 100 shown in FIG. 3, the water guided into the casing 3 can be recirculated in any case of how the hydraulic piston pump motor 100 is used.

Next describes the cooling effect in a case of using the modified example shown in FIG. 3 as the piston motor. As shown by the arrows in FIG. 3, a portion of the water supplied to the piston motor circulates within the piston motor, and cools each of the portions.

The supply passage 10 serves as a high pressure passage through which high pressure water supplied from the outside flows, and the discharge passage 11 communicates with a tank not illustrated, and serves as a low pressure passage through which water discharged from the capacity chamber 7 flows. Therefore, the supply passage 10 through which the water with high pressure flows communicates with the introduction passage 13 via the selector valve 32. The water guided from the supply passage 10 through the introduction passage 13 is guided into the casing 3 through the axial directional passage 15 formed in the shaft 1 and cools each of the sliding portions, as with the case of the piston pump 200 shown in FIG. 1. The water guided into the casing 3 is guided to the discharge passage 11, through which low pressure water flows, via the check valve 33b provided in the passage 19b communicating with the discharge passage 11, and is discharged to the tank together with the water discharged from the capacity chamber 7. When the passage which supplies the high pressure water is switched from the supply passage 10 to the discharge passage 11, to switch the rotational direction of the shaft 1, the passage communicating with the introduction passage 13 is switched from the supply passage 10 to the discharge passage 11 through which the water with high pressure flows, by the selector valve 32. Accordingly, the water is guided from the discharge passage 11 into the casing 3, and the water guided into the casing 3 is guided to the supply passage 10 communicating with the tank through the check valve 33a provided in the passage 19a that communicates with the supply passage 10. Any other effects are identical to the piston pump 200 shown in FIG. 1, and thus the descriptions thereof have been omitted.

As described above, even in the modified example shown in FIG. 3, the water guided into the shaft 1 is guided into the casing 3 through the two passages of the first radial directional passage 16 and the second radial directional passage 17, so it is thus possible to simultaneously and efficiently cool the sliding portions of each of the bearings and spline coupling portions. Therefore, the erosion and abnormal wear occurring due to frictional heat is suppressed, thus the durability of the hydraulic rotary machine is improved. Furthermore, in this modified example, regardless of the rotational direction of the shaft 1, high pressure water can constantly be guided inside the casing 3 in any case of how the hydraulic piston pump motor 100 is used.

The embodiments of the present invention described above are merely illustration of some application examples of the present invention and not of the nature to limit the technical scope of the present invention to the specific constructions of the above embodiments.

The present application claims a priority based on Japanese Patent Application No. 2014-139544 filed with the Japan Patent Office on Jul. 7, 2014, all the contents of which are hereby incorporated by reference.

1. A hydraulic rotary machine in which water is used as a working fluid, comprising:
a plurality of pistons;
a cylinder block having a plurality of cylinders which accommodates the pistons and being rotatable;
a shaft penetrating through the cylinder block and coupling to the cylinder block;
a swash plate configured to reciprocate the piston in accordance with the rotation of the cylinder block so as to expand and contract a capacity chamber of the cylinder;
a casing accommodating the cylinder block, the casing supporting one end of the shaft, the other end of the shaft being inserted through the casing;
a supply passage provided in the casing and configured to supply the working fluid to the capacity chamber;
a discharge passage provided in the casing and configured to introduce the working fluid discharged from the capacity chamber;
an axial directional passage opened on an end surface of the one end of the shaft and drilled open along a shaft center of the shaft;
a first radial directional passage drilled open along a radial direction of the shaft from the axial directional passage and configured to guide the working fluid inside the casing;
a second radial directional passage drilled open along the radial direction of the shaft from the axial directional passage at a position closer to the one end of the shaft than the first radial directional passage and configured to guide the working fluid inside the casing; and
an introduction passage configured to communicate a passage, through which the higher pressure working fluid flows, among the supply passage and the discharge passage with the axial directional passage.

2. The hydraulic rotary machine according to claim 1, wherein
the introduction passage comprises an orifice configured to limit the amount of the working fluid guided to the axial directional passage.

3. The hydraulic rotary machine according to claim 1, further comprising:
a recirculation passage configured to guide the working fluid guided inside the casing through the first radial directional passage and the second radial directional passage to a passage, through which the lower pressure working fluid flows, among the supply passage and the discharge passage.

4. The hydraulic rotary machine according to claim 1, further comprising:
a first bearing interposed between the casing and the other end of the shaft, supporting the shaft in a rotatable manner, and configured to allow the working fluid guided from the first radial directional passage to flow;
a second bearing interposed between the casing and the cylinder block, supporting the cylinder block in a rotatable manner, and configured to allow the working fluid guided from the second radial directional passage to flow; and
a third bearing interposed between the casing and a leading end portion of the one end of the shaft, supporting the leading end portion of the shaft in a rotatable manner, and configured to allow the working fluid guided from the introduction passage to flow.

5. The hydraulic rotary machine according to claim 1, wherein
the hydraulic rotary machine is used as a pump, and
the introduction passage is a passage connecting the discharge passage, through which the working fluid pressurized in the capacity chamber flows, with the axial directional passage.

6. The hydraulic rotary machine according to claim 1, wherein
the hydraulic rotary machine is used as a motor, and
the introduction passage is a passage connecting the supply passage, through which the working fluid supplied from the outside flows, with the axial directional passage.
